(19) United States
(12) Patent Application Publication
(10) Pub. No.: US 2019/0146545 A1
(43) Pub. Date: May 16, 2019

(54) Non-Slip Article and Method of Use Thereof

(71) Applicant: Jonathan Morse, Berry Hill, TN (US)

(72) Inventor: Jonathan Morse, Berry Hill, TN (US)

(21) Appl. No.: 15/815,400

(22) Filed: Nov. 16, 2017

(51) Int. Cl. G05G 1/483; G05G 1/487

(52) U.S. Cl. CPC G05G 1/483; G05G 1/487; B29K 2995/0072; B32B 2266/0278; B32B 2307/744; B32B 2266/0235

(57) ABSTRACT

Provided herein are an article and method for reducing or eliminating movement of a device. The article includes a top surface including a first material and a bottom surface including a second material. The first material is arranged and disposed to engage a corresponding material and the second material is a non-slip material arranged and disposed to engage a supporting surface. The method of reducing movement of a device includes providing an article including a top surface having a first material and a bottom surface having a non-slip second material; providing a device having a corresponding material attached thereto; placing the non-slip second material of the article in contact with a support surface; and placing the corresponding material on the device in contact with the first material on the article. Also provided herein is a system including an article and a device.

### TECHNICAL FIELD

The present invention relates to non-slip articles, systems, and methods for use thereof. In particular, the presently-disclosed subject matter relates to a non-slip article for use with a foot pedal, and a method of use thereof.

### BACKGROUND

When musicians play a keyboard or other digital instrument, they often use a foot pedal. In general, foot pedals permit the musician to modify an aspect of the sound with their foot while continuing to play music with their fingers/hands. For example, foot pedals may be used to modify the damper, or increase the length of a note played by a single key stroke. As the ability to modify the sound of an instrument while continuing to play is critical for many different songs, foot pedals are considered an important and integral part of keyboards and other digital musical instruments. While some foot pedals are stationary and fixed to a device, such as a piano, others are portable and/or movable with respect to the device, such as with a keyboard. These portable and/or movable foot pedals can slide during use, which affects both performance and user comfort.

One attempt to address the challenges associated with portable and/or movable foot pedals included adding an extension to the foot pedal, such that a user can hold the foot pedal in place using their heel. However, this requires the user to keep their heel on the extension while pressing the foot pedal, which can be difficult and/or affect performance. Additionally, it can be uncomfortable for users to keep their heel on the foot pedal extension during use. Furthermore, the extension is brand specific and does not work with other pedals, thus limiting a performer's ability to use the pedal of their choice. Still further, although foot pedals have a high rate of failure, the existing extension is integral with the pedal and cannot be transferred to when/if the pedal fails.

Accordingly, there is a need for articles and methods that prevent movement of foot pedals during use.

### SUMMARY

This summary describes several embodiments of the presently-disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently-disclosed subject matter, whether listed in this summary or not. To avoid excessive repetition, this summary does not list or suggest all possible combinations of features.

The presently-disclosed subject matter provides, in some embodiments, an article including a top surface including a first material and a bottom surface including a second material, wherein the first material is arranged and disposed to engage a corresponding material and the second material is a non-slip material arranged and disposed to engage a supporting surface. In some embodiments, the first material and the corresponding material together form a reclosable fastener selected from the group consisting of hook and loop fasteners, slidingly engaging fasteners, and interlocking fasteners. In one embodiment, the first material and the corresponding material together form hook and loop fasteners. In some embodiments, the corresponding material is arranged and disposed for attachment to a device. In some embodiments, the device is a foot pedal.

In some embodiments, the second material is selected from the group consisting of rubber, polymer, cork, felt, and combinations thereof. In one embodiment, the rubber is selected from the group consisting of isoprene, ethylene propylene diene monomer (EPDM), neoprene, and combinations thereof. In another embodiment, the rubber is neoprene. In one embodiment, the polymer is selected from the group consisting of plastics, thermoplastics, thermosets, polymer resins, and combinations thereof. In one embodiment, the polymer is selected from the group consisting of silicone, polyvinyl chloride (PVC), polyethylene, polyurethane, acrylic, polyester, and combinations thereof. In another embodiment, the polymer is silicone. In some embodiments, the second material is selected from the group consisting of solid, perforated, foam, sponge, woven, mesh, net, corrugated, and combinations thereof. In one embodiment, the second material is a mesh.

The presently-disclosed subject matter also provides, in some embodiments, a method of reducing movement of a device, the method including providing an article comprising a top surface including a first material and a bottom surface including a non-slip second material; providing a device having a corresponding material attached thereto; placing the non-slip second material of the article in contact with a support surface; and placing the corresponding material on the device in contact with the first material on the article. In some embodiments, the step of providing a device having a corresponding material attached thereto includes attaching the corresponding material to the device. In some embodiments, the method further comprises rolling and unrolling the article between uses. In some embodiments, the first material and the corresponding material form hook and loop fasteners. In some embodiments, the device is a foot pedal.

The presently-disclosed subject matter further provides, in some embodiments, a system including an article comprising a top surface including a first material and a bottom surface including a non-slip second material; and a device including a corresponding material attached thereto; wherein the corresponding material on the device is arranged and disposed to engage the first material of the article and reversibly secure the device to the article. In some embodiments, the device is a foot pedal.

### BRIEF DESCRIPTION OF THE DRAWINGS

The presently-disclosed subject matter will be better understood, and features, aspects and advantages other than those set forth above will become apparent when consideration is given to the following detailed description thereof. Such detailed description makes reference to the following drawings, wherein:

FIG. 1 is an exploded view of an article and corresponding material, according to an embodiment of the disclosure.

FIG. 2 is a perspective view of a corresponding material attached to a device, according to an embodiment of the disclosure.

FIG. 3 is a perspective view of a single device secured to an article, according to an embodiment of the disclosure.

FIG. 4 is a perspective view of multiple devices secured to an article, according to an embodiment of the disclosure.

While the disclosure is susceptible to various modifications and alternative forms, specific embodiments thereof have been shown by way of example in the drawings and are herein described below in detail. It should be understood, however, that the description of specific embodiments is not intended to limit the disclosure to cover all modifications, equivalents and alternatives falling within the spirit and scope of the disclosure as defined by the appended claims.

### Definitions

Unless defined otherwise, all technical and scientific terms used herein have the same meaning as commonly understood by one of ordinary skill in the art to which the disclosure belongs. Any methods and materials similar to or equivalent to those described herein can be used in the practice or testing of the present disclosure, including the methods and materials are described below.

Following long-standing patent law convention, the terms “a,” “an,” and “the” refer to “one or more” when used in this application, including the claims. Thus, for example, reference to “a cell” includes a plurality of cells, and so forth.

The terms “comprising,” “including,” and “having” are intended to be inclusive and mean that there may be additional elements other than the listed elements.

Unless otherwise indicated, all numbers expressing quantities of ingredients, properties such as reaction conditions, and so forth used in the specification and claims are to be understood as being modified in all instances by the term “about.” Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration, percentage, or the like is meant to encompass variations of in some embodiments ±50%, in some embodiments ±40%, in some embodiments ±30%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

All combinations of method or process steps as used herein can be performed in any order, unless otherwise specified or clearly implied to the contrary by the context in which the referenced combination is made.

### DETAILED DESCRIPTION

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

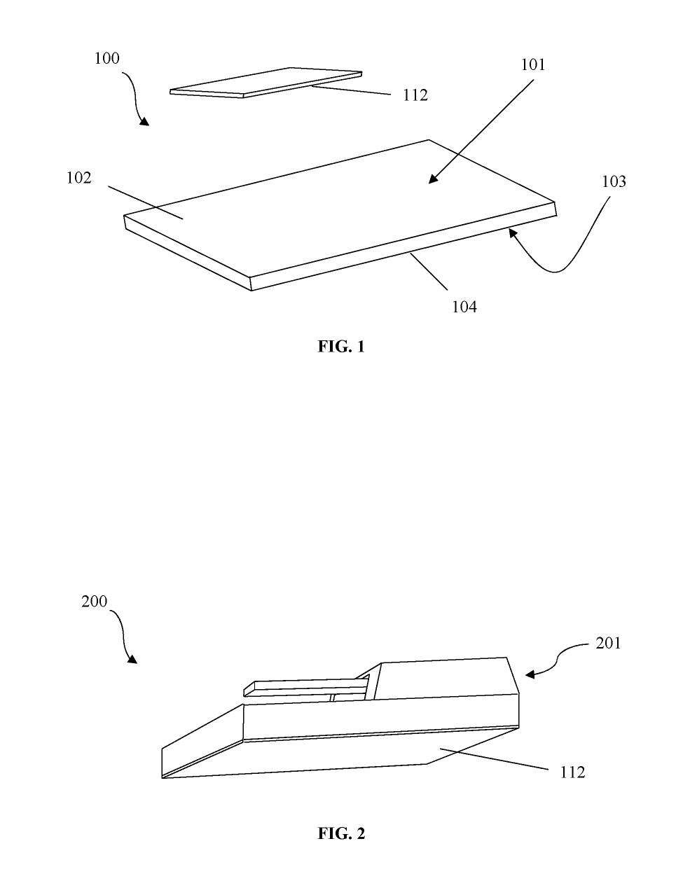

The presently-disclosed subject matter relates to non-slip articles and methods for use thereof. Referring to FIG. 1, in some embodiments, the article 100 includes a top surface 101 formed from a first material 102 and an opposite facing bottom surface 103 formed from a second material 104. The first material 102 includes any suitable material for engaging with a corresponding material 112. For example, in one embodiment, the first material 102 and the corresponding material 112 include hook and loop fasteners, slidingly engaging fasteners, interlocking fasteners, or any other suitable reclosable fastener. In another embodiment, the first material 102 and the corresponding material 112 include hook and loop fasteners.

The second material 104 on the bottom surface 103 of the article 100 includes any suitable non-slip material for engaging an opposing surface to reduce or eliminate movement of the article 100 with respect thereto. Suitable non-slip materials include, but are not limited to, rubbers, such as traditional rubber (isoprene), ethylene propylene diene monomer (EPDM), neoprene, and/or any other suitable rubber; polymers, such as silicone, polyvinyl chloride (PVC), polyethylene, polyurethane, acrylic, polyester, other plastics, other thermoplastics, other thermosets, other polymer resins, and/or any other suitable polymer; cork; felt; or a combination thereof. For example, in one embodiment, the second material 104 includes neoprene. In another embodiment, the second material 104 includes silicone. Additionally or alternatively, the second material 104 may include any suitable configuration, such as, but not limited to, solid, perforated, foam, sponge, woven, mesh, net, corrugated, or a combination thereof. For example, in certain embodiments, the second material 104 includes a silicone mesh.

Referring to FIG. 2, the corresponding material 112 is attached and/or secured to any suitable device 200 using any suitable attachment element. Suitable devices include, but are not limited to, a foot pedal 201, a switch, or any other portable device that may be activated by foot. Suitable attachment elements include, but are not limited to, adhesives, double sided tapes, staples, tacks, and/or any other element capable of securing the corresponding material 112 to the device 200. For example, in one embodiment, the corresponding material 112 is attached to a foot pedal 201 using an adhesive. In another embodiment, the corresponding material 112 is attached to a foot pedal 201 using a double sided tape. Additionally or alternatively, the corresponding material 112 may be secured to a clip, clamp, tray, or other attachment element suitable for reversibly attaching to the device 200. In such embodiments, various different devices 200 may be interchangeably attached to the corresponding material 112 through the attachment element.

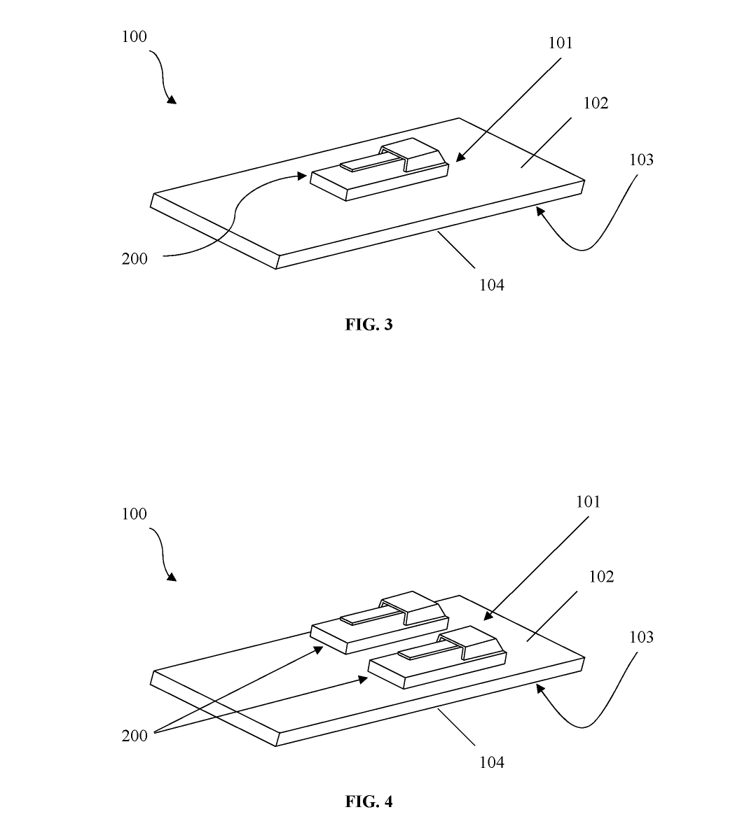

Turning to FIG. 3, when the first material 102 engages the corresponding material 112, it maintains the position of a device 200 attached thereto with respect to the article 100. As discussed above, the second material 104 on the opposite facing bottom surface 103 simultaneously maintains the position of the article 100 with respect to a supporting surface, such as a floor, a stage, or any other supporting surface. Accordingly, in some embodiments, the article 100 reduces or eliminates slipping and/or movement of the device 200 with respect to a supporting surface during use. In contrast to existing articles, the article 100 disclosed herein reduces or eliminates slipping of the device 200 without requiring a user to place their heel in contact with the article 100. As such, the device 200 may be placed anywhere on the top surface 101 of the article 100, permitting the user to choose whether their heel rests on the article 100 during use. In certain embodiments, where the user chooses to rest their heel on the article 100 during use, the article 100 may additionally provide a cushioning effect for the user.

Referring now to FIG. 4, in some embodiments, the article 100 may be sized for use with more than one device 200. For example, in one embodiment, at least two devices 200 may be attached to the article 100 with the corresponding material 112. In another embodiment, three or more devices 200 may be attached to the article 100. Accordingly, as will be appreciated by those skilled in the art, the length and width of the article 100 is not limited to any particular dimension and may include any suitable size for the number of devices being used.

Additionally or alternatively, in some embodiments, the article 100 is flexible and/or bendable. In one embodiment, the flexible and/or bendable article 100 may be folded and/or rolled when the device 200 is not attached thereto, facilitating easy storage and transportation between uses. In another embodiment, the flexible and/or bendable article 100 may be folded and/or rolled around the device 200 to provide cushioning and/or protections of the device while also facilitating easy storage and transportation thereof.

Also provided herein is a method of reducing or eliminating movement of a device during use, the method including placing the second material 104 on the bottom surface 103 of the article 100 in contact with a support surface, and placing the corresponding material 112 on the device 200 in contact with the first material 102 on the top surface 101 of the article 100. Once in contact, the corresponding material 112 and the first material 102 maintain a position of the device 200 with respect to the article 100. Additionally, once the second material 104 is in contact with the supporting surface, it maintains a position of the article 100 with respect to the supporting surface. In one embodiment, the method also includes securing the corresponding material 112 to the device 200. In another embodiment, the securing may be permanent, such as through an adhesive, or reversible, such as through a clip, clamp, or tray. In a further embodiment, the method includes removing the corresponding material 112 from contact with the first material 102 and/or folding/rolling the article 100 for transportation and/or storage.

In certain embodiments, the second material 104 is perforated, woven, mesh, net-like, or otherwise includes recesses/openings formed therein. When present, these recesses/openings may facilitate direct contact between the second material 104 and the support surface when moisture is present by providing passages for accommodating the moisture. As such, in some embodiments, the article 100 reduces or eliminates movement of the device 200 on both wet and dry surfaces.

While the disclosure is susceptible to various modifications and alternative forms, specific embodiments thereof have been shown by way of example in the drawings and are herein described below in detail. It should be understood, however, that the description of specific embodiments is not intended to limit the disclosure to cover all modifications, equivalents and alternatives falling within the spirit and scope of the disclosure as defined by the appended claims.

What is claimed is:

1. An article, comprising:
a top surface including a first material; and
a bottom surface including a second material;
wherein the first material is arranged and disposed to engage a corresponding material; and
wherein the second material is a non-slip material arranged and disposed to engage a supporting surface.

2. The article of claim 1, wherein the first material and the corresponding material together form a reclosable fastener selected from the group consisting of hook and loop fasteners, slidingly engaging fasteners, and interlocking fasteners.

3. The article of claim 2, wherein the first material and the corresponding material together form hook and loop fasteners.

4. The article of claim 1, wherein the second material is selected from the group consisting of rubber, polymer, cork, felt, and combinations thereof.

5. The article of claim 4, wherein the rubber is selected from the group consisting of isoprene, ethylene propylene diene monomer (EPDM), neoprene, and combinations thereof.

6. The article of claim 5, wherein the rubber is neoprene.

7. The article of claim 4, wherein the polymer is selected from the group consisting of plastics, thermoplastics, thermosets, polymer resins, and combinations thereof.

8. The article of claim 4, wherein the polymer is selected from the group consisting of silicone, polyvinyl chloride (PVC), polyethylene, polyurethane, acrylic, polyester, and combinations thereof.

9. The article of claim 8, wherein the polymer is silicone.

10. The article of claim 1, wherein the second material is selected from the group consisting of solid, perforated, foam, sponge, woven, mesh, net, corrugated, and combinations thereof.

11. The article of claim 10, wherein the second material is a mesh.

12. The article of claim 1, wherein the corresponding material is arranged and disposed for attachment to a device.

13. The article of claim 1, wherein the device is a foot pedal.

14. A method of reducing movement of a device, the method comprising:
providing an article comprising:
a top surface including a first material; and
a bottom surface including a non-slip second material;
providing a device having a corresponding material attached thereto;
placing the non-slip second material of the article in contact with a support surface; and
placing the corresponding material on the device in contact with the first material on the article.

15. The method of claim 14, wherein the step of providing a device having a corresponding material attached thereto includes attaching the corresponding material to the device.

16. The method of claim 14, further comprising rolling and unrolling the article between uses.

17. The method of claim 14, wherein the first material and the corresponding material form hook and loop fasteners.

18. The method of claim 14, wherein the device is a foot pedal.

19. A system, comprising:
an article including:
a top surface including a first material; and
a bottom surface including a non-slip second material; and
a device including a corresponding material attached thereto;
wherein the corresponding material on the device is arranged and disposed to engage the first material of the article and reversibly secure the device to the article.

20. The system of claim 19, wherein the device is a foot pedal.
